(19) United States
(12) Patent Application Publication
(10) Pub. No.: US 2005/0168645 A1
(43) Pub. Date: Aug. 4, 2005

(54) Adjusting circuit and method

(75) Inventor: Tatsuro Yamazaki, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/042,170

(22) Filed: Jan. 26, 2005

(30) Foreign Application Priority Data
Feb. 2, 2004 (JP) 2004-025369
Jan. 17, 2005 (JP) 2005-008655

(51) Int. Cl. H04N 9/73; G09G 5/10

(52) U.S. Cl. 348/655; 345/690

(57) ABSTRACT

An adjusting circuit comprises: a correction circuit for correcting the fluorescent intensities of the individual three primaries independently with changeable correction values to change a white color temperature; a matrix operation circuit for performing matrix operations on three color signals corresponding to the individual three primaries using the three color signals inputted and changeable matrix coefficients, thereby to output three new color signals; and a control circuit for making a control to change said matrix coefficients and said correction values in conjunction with the change in each other.

### BACKGROUND OF THE INVENTION

1. Field of the Invention

The present invention relates to an adjusting circuit for an image display apparatus and, more particularly, to an adjusting circuit for use in an image display apparatus such as a PDP (Plasma Display Panel), an LCD, an FED (Field Emission Display), an LED display or an EL display. The image display apparatus is suitably used as the monitor of a personal computer or a television set.

2. Description of the Related Art

The configuration of Patent Publication 1 is known as an example of the television receiver, which receives television signals or display signals from a computer and displays them as an image by using a display panel including a plurality of electron emission devices and a fluorescent face for fluorescing when it receives the irradiation of electron beams of the electron emitting devices.

The configuration of Patent Publication 3 is known as an example of the color temperature adjustment in a display apparatus using a Braun tube. The configuration of Patent Publication 4 is known as an example of the color temperature adjustment in the PDP apparatus. Moreover, the configuration of Patent Publication 2 is known as an example for the color reproduction of a liquid crystal display apparatus for the CRT compatibility.

[Patent Publication 1]
JP-A-6-342636 (U.S. Pat. No. 5,659,329)

[Patent Publication 2]
JP-A-2002-232905 (USAA 2002135828)

[Patent Publication 3]
JP-A-8-163582

[Patent Publication 4]
JP-A-2001-265277 (USAA 2002011795)

### SUMMARY OF THE INVENTION

In the related art of the image display apparatus capable of adjusting the color temperature, either the luminescent level ratios of RGB colors or the signal level ratios of the RGB colors are adjusted, as disclosed in Patent Publication 3 or Patent Publication 4. In this color temperature adjustment of the related art, it is certain that a white color can be controlled to a desired color temperature, but colors other than the white color may go wrong with that color temperature adjustment.

FIG. 6 shows one example of the color reproduction on an x-y chromaticity diagram in the color temperature adjustment of the related art. In a case the signal level ratios of the RGB colors are changed to desired values so as to change the white color temperature from W1 to W2 in FIG. 6, the magenta color, for example, moves from Mg1 to Mg2 on FIG. 6.

In a case the white color temperature is set to W1 and in a case the magenta color has the color coordinates Mg1, the color reproduction point moves on a straight line from Mg1 to W1 in accordance with the signal level of the green color.

In a case the white color temperature is set to W2 and in a case the magenta color has the color coordinates Mg2, on the other hand, the color reproduction point moves on a straight line from Mg2 to W2 in accordance with the signal level of the green color.

It is apparent from FIG. 6 that the distances on the color coordinates are unequal on the straight line W1-Mg1 and the straight line W2-Mg2 so that the color difference fluctuates on the two straight lines according to the signal level of the green color.

The present invention has been conceived to solve the aforementioned problems of the related art, and has an object to provide a technique for realizing a proper color reproduction range display not only for the white color at the color temperature varying time but also at another color displaying time.

In order to achieve the above-specified object, the invention adopts the following configurations.

Specifically, an adjusting circuit comprising: a correction circuit for correcting the fluorescent intensities of the individual three primaries independently with changeable correction values to change a white color temperature; a matrix operation circuit for performing matrix operations on three color signals corresponding to the individual three primaries using the three color signals inputted and changeable matrix coefficients, thereby to output three new color signals; and a control circuit for making a control to change said matrix coefficients and said correction values in conjunction with the change in each other.

An adjusting circuit comprising: a correction circuit for correcting the three color signals corresponding to the individual three primaries with changeable correction values to change a white color temperature; a matrix operation circuit for performing matrix operations on three color signals corresponding to the individual three primaries using the three color signals inputted and changeable matrix coefficients, thereby to output three new color signals; and a control circuit for making a control to change said matrix coefficients and said correction values in conjunction with the change in each other.

An adjusting circuit comprising: a correction circuit for correcting such that drive signals corrected with changeable correction values are outputted as drive signals for driving devices to be driven in order to produce modulated lights of individual three primaries, to change a white color temperature; a matrix operation circuit for performing matrix operations on three color signals corresponding to the individual three primaries using the three color signals inputted and changeable matrix coefficients, thereby to output three new color signals; and a control circuit for making a control to change said matrix coefficients and said correction values in conjunction with the change in each other.

In the aforementioned adjusting circuits, said correction values and said matrix coefficients satisfy such relationship that, in cases where the change of said correction values lead to drop of the color temperature, the change of matrix coefficients in associated with the change in said correction values shift the origin of green in the color space to red.

An image display apparatus comprising: the aforementioned adjusting circuit; and a display panel for displaying an image in accordance with the three color signals outputted from the adjusting circuit.

A television set comprising: the aforementioned image display apparatus; and a receiving circuit for receiving television signals to feed the image display apparatus with image data.

An adjusting method comprising: a correction step of correcting fluorescent intensities of individual three primaries independently with changeable correction values to change a white color temperature; and a matrix operation step of performing matrix operations on three color signals corresponding to the individual three primaries using the three color signals inputted and changeable matrix coefficients, thereby to output three new color signals. In the adjusting method, a control is made to change said matrix coefficients and said correction values in conjunction with the change in each other.

An adjusting method comprising: a correction step of correcting the three color signals corresponding to the individual three primaries with changeable correction values to change a white color temperature; and a matrix operation step of performing matrix operations on three color signals corresponding to the individual three primaries using the three color signals inputted and changeable matrix coefficients, thereby to output three new color signals. In the adjusting method, a control is made to change said matrix coefficients and said correction values in conjunction with the change in each other.

An adjusting method comprising: a correction step of correcting such that drive signals corrected with changeable correction values are outputted as drive signals for driving devices to be driven in order to produce modulated lights of individual three primaries, to change a white color temperature; and a matrix operation step of performing matrix operations on three color signals corresponding to the individual three primaries using the three color signals inputted and changeable matrix coefficients, thereby to output three new color signals. In the adjusting method, a control is made to change said matrix coefficients and said correction values in conjunction with the change in each other.

In the aforementioned adjusting method, said correction values and said matrix coefficients satisfy such relationship that, in cases where the change of said correction values lead to drop of the color temperature, the change of matrix coefficients in associated with the change in said correction values shift the origin of green in the color space to red.

According to the invention, the image display can be made within a proper color reproduction range in accordance with the individual color temperature settings. According to the invention, moreover, it is possible to make a fine color adjustment.

### BRIEF DESCRIPTION OF THE DRAWINGS

FIG. 1 is a diagram showing a configuration of a color conversion unit according to a first embodiment;

FIG. 2 is an example of a color reproduction on an x-y chromaticity diagram in a color temperature adjustment of the invention;

FIG. 3 is a diagram showing a configuration of an image display apparatus according to a second embodiment;

FIG. 4 is a diagram showing a configuration of a color conversion unit according to a second embodiment;

FIG. 5 is a block diagram of a television set according to the invention; and

FIG. 6 is an example of a color reproduction on an x-y chromaticity diagram in a color temperature adjustment of the related art.

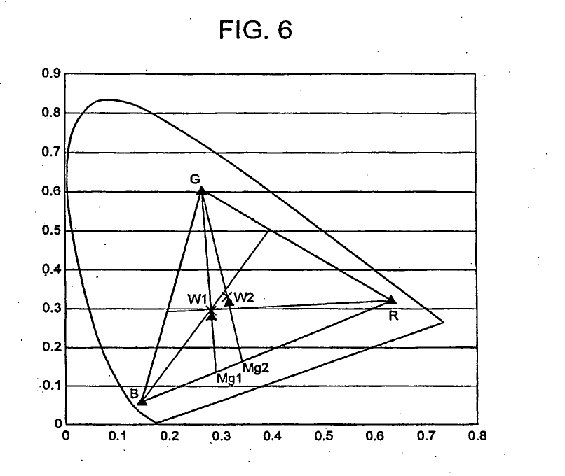

### DETAILED DESCRIPTION OF THE PREFERRED EMBODIMENTS

The best mode of embodiment of the invention will be illustratively described in detail with reference to the accompanying drawings. However, the sizes, materials, shapes and relative arrangements of components described in the embodiment are not intended to limit the scope of the invention thereto, so long as they are not especially specified.

### Embodiment of Television Set

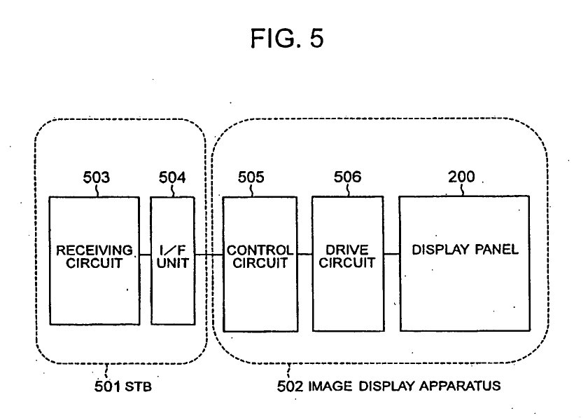

First of all, the television set, to which the invention is applied, is described with reference to FIG. 5. FIG. 5 is a block diagram of the television set according to the invention. The television set is provided with a set top box (STB) 501 and an image display apparatus 502.

The set top box (STB) 501 includes a receiving circuit 503 and an I/F unit 504. The receiving circuit 503 is composed of a tuner, a decoder and so on. The receiving circuit 503 receives TV signals of the satellite broadcast, the ground waves, the data broadcast via the network or the like, and outputs the decoded video data to the I/F unit 504. This I/F unit 504 converts the video data into the display format of the image display apparatus 502 and outputs the image data to the image display apparatus 502.

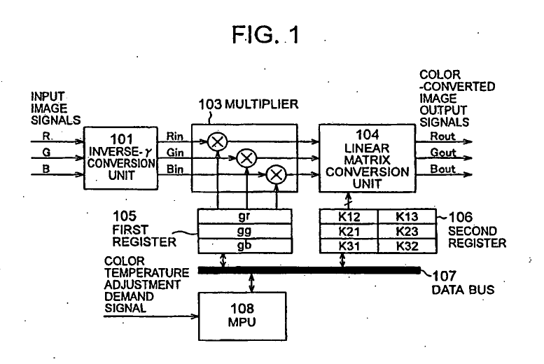

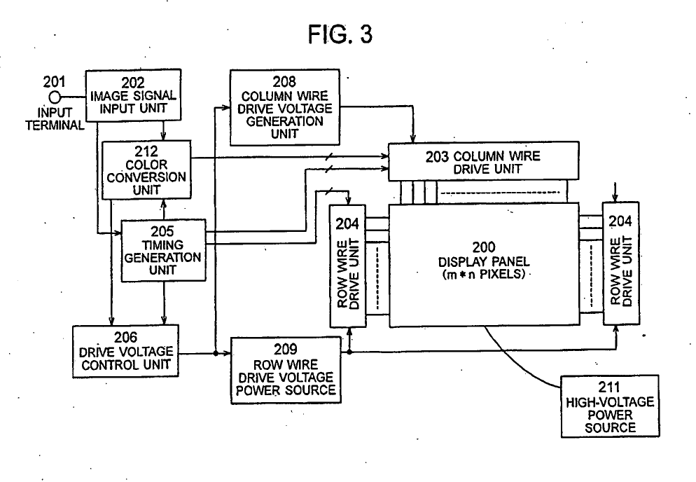

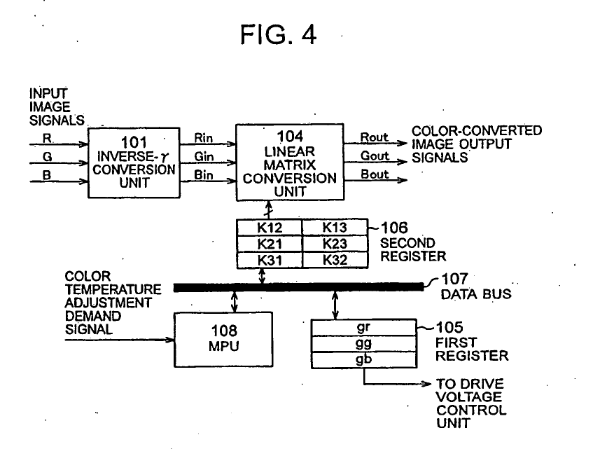

This image display apparatus 502 includes a display panel 200, a control circuit 505, a drive circuit 506 and an adjusting circuit (or a color conversion unit) of the invention. The image data from the I/F unit 504 are once decoded in the image signal input unit into RGB signals, which are inputted to the adjusting circuit. Specifically, the input terminal 201 of FIG. 3 is connected with I/F unit 504 of FIG. 5 and the image data from the I/F unit 504 are inputted to an image signal input unit 202 of FIG. 3. The RGB signals decoded by the image signal input unit 202 are inputted as input image signals to an inverse-γ conversion unit 101, as shown in FIG. 1 or FIG. 4, of the color conversion unit acting as the adjusting circuit.

Moreover, the control circuit 505 included in the image display apparatus 502 subjects the inputted image data to an image processing such as a correction processing suited for the display panel 200, and outputs the image data and various control signals to the drive circuit 506. The control circuit 505 is exemplified by a timing generation unit 205 and a drive voltage control unit 206, as shown in FIG. 3. On the basis of the inputted image data, the drive circuit 506 outputs a drive signal to the display panel 200 so that a television image is displayed on the display panel 200. The drive circuit 506 is exemplified by a row wire drive unit 203 and a column wire drive unit 204, as shown in FIG. 3. In the following embodiments, the display panel 200 is exemplified by an FED using an electron emitting device, as shown in FIG. 3. In the invention, however, the display panel 200 should not be limited to the FED but can be exemplified by various display panels such as the PDP, the LCD display or the EL display.

Here, the receiving circuit 503 and the I/F unit 504 may be housed as the set top box (STB) 501 in a cabinet common to or different from that of the image display apparatus 502.

### First Embodiment

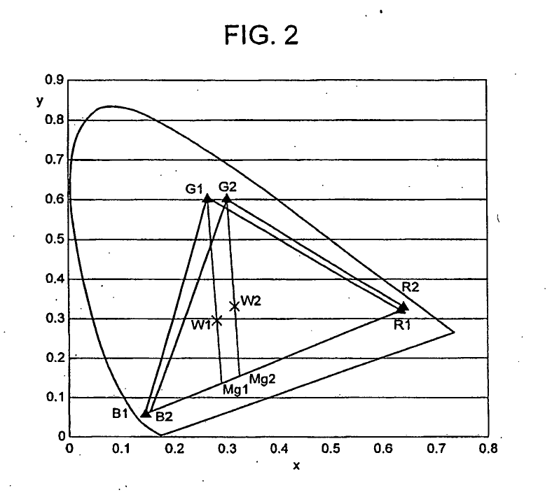

A first embodiment will be described with reference to FIG. 1 and FIG. 2. FIG. 1 shows the construction of a color conversion unit in the first embodiment. The color conversion unit is a unit corresponding to the adjusting circuit in the image display apparatus. The input image signals to be inputted to the color conversion unit are the RGB signals, which are decoded by the not-shown image signal input unit from the image data coming from the I/F unit 504 of FIG. 5. From the color conversion unit, moreover, the color conversion image output signals are outputted to the not-shown row wire drive unit. The color conversion unit includes the inverse-γ conversion unit 101, a multiplier 103 corresponding to a correction circuit; a linear matrix conversion unit 104 corresponding to a matrix operation circuit, a first register 105, a second register 106, a data bus 107, and an MPU 108 corresponding to the control circuit.

In FIG. 1, the inverse-γ conversion unit 101 performs a processing to cancel the gamma conversion on image signals R, G and B, which are gamma-converted and inputted in advance.

The multiplier 103 is provided for each of the RGB. This multiplier 103 multiplies the output image signal from the inverse-γ conversion unit 101 and each of the gain coefficients (gr, gg and gb) or the output signals from the first register 105 for the RGB, and outputs the products to the linear matrix conversion unit 104. The output image signals from the inverse-γ conversion unit 101 designate the three color signals individually corresponding to the three primaries, and the gain coefficients (gr, gg and gb) designate the corrected values. Here, the multiplications of the output image signals and the gain coefficients are the corrections to change the white color temperature of the invention and, and change the intensity ratios of R/G/B for every colors.

The linear matrix conversion unit 104 performs operations to mix the RGB on the basis of matrix coefficients (K12, K13, K21, K23, K31 and K32) or the output signals from the second register 106, and outputs the color conversion image output signals to the not-shown image display unit such as the row wire drive unit. The color conversion image output signals designate the new color signals after the matrix operations.

Here, the not-shown image display unit (or the display panel) is premised by a device driven with a pulse width proportional to brightness data, so that the brightness data and the luminescent intensity are in a substantially linear relation.

Moreover, the embodiment is provided with the MPU 108 and can change the coefficient data to be stored through the data bus 107 in the first register 105 and the second register 106.

The relation thus far described is expressed by the following Formula:

$$( \begin{matrix}Rout \\ Gout \\ Bout\end{matrix} ) = ( \begin{matrix}1 & K12 & K13 \\ K21 & 1 & K23 \\ K31 & K32 & 1\end{matrix} ) ( \begin{matrix}gr \times Rin \\ gg \times Gin \\ gb \times Bin\end{matrix} ) \qquad [ Formula 1 ]$$

Here, it is assumed that a color reproduction mode 1 is set when the image display in the embodiment is in the initial state, and that the mode is changed into a color reproduction mode 2 when the MPU 108 is caused to receive a color temperature adjustment demand signal by the operation of the user of the image display apparatus, although not shown.

The color reproduction mode 1 and the color reproduction mode 2 are illustrated by color reproduction ranges, as shown in FIG. 2. The color reproduction mode 1 is defined by a triangular area, which is formed by joining a white point W1 and a color reproduction range R1/G1/B1, as indicated on the x-y coordinate axes of FIG. 2, with straight lines. The color reproduction mode 2 is defined by a triangular area, which is formed by joining a white point W2 and a color reproduction range R2/G2/B2, as indicated on the x-y coordinate axes of FIG. 2, with straight lines.

In the color temperature adjustment of the related art, the white color is adjusted by changing only the intensity ratios of R/G/B. In the embodiment, however, the intensity ratios of R/G/B are changed by changing the gain coefficients (gr, gg and gb), and the matrix coefficients (K12, K13, K21, K23, K31 and K32) are also changed in association with the gain coefficient changes. In the embodiment, the associated changes of the gain coefficients (gr, gg and gb) and the matrix coefficients (K12, K13, K21, K23, K31 and K32) mean that the desired white color temperature adjustment W1→W2 and the color reproduction range ΔR1G1B1→ΔR2G2B2 move in the same direction in the x-y coordinate system, as shown in FIG. 2.

According to the embodiment, the matrix coefficients (K12, K13, K21, K23, K31 and K32) can also be thus changed in association with the gain coefficient changes so that the color temperature adjustment and the satisfactory color reproduction can be made compatible.

Here, the invention has been described with the embodiment, in which the color temperature adjustment demand signal is generated by the operation of the user of the image display apparatus. However, the invention should not be limited to that embodiment, but the color temperature adjustment demand signal may be generated either by detecting the environmental conditions (e.g., the brightness or hue of an illuminating light) of the place where the image display apparatus is installed, for example, by detecting the kind (e.g., a computer signal, a movie source of DVD or the like, or a reception of a TV broadcast) of the image signals inputted to the image display apparatus.

In addition, the color reproduction ranges change and the color temperature adjustment should be performed just in conjunction with each other. Therefore, the signal used as the cause of change of a setting may not be the color temperature adjustment demand signal, but may be a color reproduction ranges change demand signal.

### Second Embodiment

A second embodiment will be described with reference to FIG. 2, FIG. 3 and FIG. 4. FIG. 3 shows the configuration of an image display apparatus according to the second embodiment. In FIG. 3, the display panel 200 is composed of a plurality of electron emitting devices and a fluorescent face for fluorescing when it receives the irradiation of electron beams of the electron emitting devices. When the plural electron emitting elements are excited by the drive signal from the row wire drive unit 203 and the column wire drive units 204, the display panel 200 has its fluorescent face excited with the emitted electron beams by the acceleration voltage from a high-voltage power source 211 so that the image display is performed. These configuration and drive method are omitted here because they are described in detail in Patent Publication 1 (JP-A-6-342636).

In the embodiment, the image display apparatus is provided with a row wire drive voltage power source 209 for generating a bias voltage to be applied to the row wires of the display panel 200, and a column wire drive voltage generation unit 208 for generating a bias voltage to be applied to the column wires of the display panel 200.

The column wire drive voltage generation unit 208 and the row wire drive voltage power source 209 have their output voltages set such that the drive voltage control unit 206 receives the control signal from a color conversion unit 212 and the control signal from the timing generation unit 205 and outputs an adjusting signal to the column wire drive voltage generation unit 208 and the row wire drive voltage power source 209.

The image signals inputted to the input terminal 201 are decoded at the image signal input unit 202 into RGB signals and are outputted to the color conversion unit 212. Synchronous signals contained in the image signals are extracted at the image signal input unit 202 and are applied to the timing generation unit 205. This timing generation unit 205 generates individual timing signals necessary for the present image display apparatus to act, and distributes the timing signals to the individual units.

FIG. 4 shows the detailed configuration of the color conversion unit 212. In FIG. 4, the inversely conversion unit 101 processes the image signals R, G and B, which are inputted after gamma-converted in advance, to cancel the gamma conversion, and output the processed image signals to the linear matrix conversion unit 104. On the basis of the matrix coefficients (K12, K13, K21, K23, K31 and K32) or the output signals from the second register 106, the linear matrix conversion unit 104 performs a mixing operation of the RGB and outputs the color conversion image output signals to the column wire drive unit 203 of the image display unit. The linear matrix conversion unit 104 corresponds to the matrix operation circuit as in the first embodiment.

The luminescent intensity ratios of the RGB are determined by the coefficients (gr, gg and gb) of the first register 105.

The image display unit is premised by a device to be driven with a pulse width proportional to the brightness data, and the brightness data and the fluorescent intensity are in a generally linear relation.

On the other hand, the column wire drive unit 203 can give different drive voltages individually to the R pixels, the G pixels and the B pixels of the display panel 200, and is fed by the column wire drive voltage generation unit 208 with a column wire applying bias voltage for the R pixels, a column wire applying bias voltage for the G pixels and a column wire applying bias voltage for the B pixels. These column wire applying bias voltage for the R pixels, column wire applying bias voltage for the G pixels and column wire applying bias voltage for the B pixels are variably controlled in the drive voltage control unit 206 with the control signals from the color conversion unit 212. These variable controls are determined by the coefficients (gr, gg and gb) of the first register 105. The drive voltage control unit 206 corresponds to the correction circuit.

Moreover, the embodiment is provided with the MPU 108 and can change the coefficient data to be stored through the data bus 107 in the first register 105 and the second register 106.

Here, it is assumed that the color reproduction mode is set when the image display in the embodiment is in the initial state, and that the mode is changed into the color reproduction mode 2 when the MPU 108 is caused to receive a color temperature adjustment demand signal by the operation of the user of the image display device, although not shown.

The color reproduction mode 1 and the color reproduction mode 2 are illustrated by color reproduction ranges, as shown in FIG. 2. The color reproduction mode 1 is defined by a triangular area, which is formed by joining a white point W1 and a color reproduction range R1/G1/B1, as indicated on the x-y coordinate axes of FIG. 2, with straight lines. The color reproduction mode 2 is defined by a triangular area, which is formed by joining a white point W2 and a color reproduction range R2/G2/B2, as indicated on the x-y coordinate axes of FIG. 2, with straight lines.

In the color temperature adjustment of the related art, the white color is adjusted by changing only the intensity ratios of R/G/B. In the embodiment, however, the intensity ratios of R/G/B are changed by changing the coefficients (gr, gg and gb) for setting the column wire applying bias voltage for the R pixels, the column wire applying bias voltage for the G pixels and the column wire applying bias voltage for the B pixels, and the matrix coefficients (K12, K13, K21, K23, K31 and K32) are also changed in association with the changes in the R/G/B intensity ratios. In the embodiment, the associated changes of the coefficients (gr, gg and gb) for setting the column wire applying bias voltage for the R pixels, the column wire applying bias voltage for the G pixels and the column wire applying bias voltage for the B pixels and the matrix coefficients (K12, K13, K21, K23, K31 and K32) mean that the desired white color temperature adjustment W1→W2 and the color reproduction range ΔR1G1B1→ΔR2G2B2 move in the same direction in the x-y coordinate system, as shown in FIG. 2.

According to the embodiment, the matrix coefficients (K12, K13, K21, K23, K31 and K32) can also be thus changed in association with the changes in the coefficients (gr, gg and gb) for setting the column wire applying bias voltage for the R pixels, the column wire applying bias voltage for the G pixels and the column wire applying bias voltage for the B pixels, so that the color temperature adjustment and the satisfactory color reproduction can be made compatible.

Here, the RGB intensity ratios have been described on the embodiment, in which the column wire applying bias voltage for the R pixels, the column wire applying bias voltage for the G pixels and the column wire applying bias voltage for the B pixels. However, the invention should not be limited to that method, but the RGB are driven with the different pulse width modulation CLK frequencies thereby to change the display period assignment percentages of the individual RGB, such that the pulse width modulation CLK frequencies for the individual RGB may be changed according to the coefficients (gr, gg and gb).

### Third Embodiment

A third embodiment will be described on the configuration, which can make a finer color adjustment.

The set data in the color reproduction mode 1 are the RGB intensity ratio coefficients (gr_1, gg_1 and gb_1) set with the white color temperature W1 and the color range matrix coefficients (K12_1, K13_1, K21_1, K23_1, K31_1 and K32_1). Moreover, the set data in the color reproduction mode 2 are the RGB intensity ratio coefficients (gr_2, gg_2 and gb_2) set with the white color temperature W2 and the color range matrix coefficients (K12_2, K13_2, K21_2, K23_2, K31_2 and K32_2). At this time, in case a white color temperature Wα intermediate between W1 and W2 is to be displayed, the RGB intensity ratio coefficients (gr_α, gg_α and gb_α) and the color range matrix coefficients (K12_α, K13_α, K21_α, K23_α, K31_α and K32_α) are determined by the interpolating operations of the MPU from the set coefficient of the white color temperature W1 and the set coefficient of the white color temperature W2 and by updating the set values of the first register and the second register.

In the interpolating operations, the calculations are made by the linear interpolations on the basis of the distance α between two points, when the relation of the white color temperature Wα intermediate between W1 and W2 is expressed by Wk=W1+(W2−W1)×α (0≦α≦1).

Thus, the finer color adjustments can be realized by acquiring the coefficient data of the two color reproduction modes which can be satisfactorily displayed, in advance and by creating the adjustment of their intermediate state by the interpolation between the coefficient data of the two modes.

In a case, moreover, the adjustment is desired to be made not only to the intermediate state between the two color reproduction modes but also to the outsides of the two modes, it may be determined by extrapolating the coefficient data.

This application claims priority from Japanese Patent Applications No. 2004-025369 filed Feb. 2, 2004, and No. 2005-008655 filed Jan. 17, 2005, which are hereby incorporated by reference herein.

1. An adjusting circuit comprising:
a correction circuit for correcting fluorescent intensities of individual three primaries independently with changeable correction values to change a white color temperature;
a matrix operation circuit for performing matrix operations on three color signals corresponding to the individual three primaries using the three color signals inputted and changeable matrix coefficients, thereby to output three new color signals; and
a control circuit for making a control to change said matrix coefficients and said correction values in conjunction with the change in each other.

2. An adjusting circuit comprising:
a correction circuit for correcting three color signals corresponding to individual three primaries with changeable correction values to change a white color temperature;
a matrix operation circuit for performing matrix operations on three color signals corresponding to the individual three primaries using the three color signals inputted and changeable matrix coefficients, thereby to output three new color signals; and
a control circuit for making a control to change said matrix coefficients and said correction values in conjunction with the change in each other.

3. An adjusting circuit comprising:
a correction circuit for correcting such that drive signals corrected with changeable correction values are outputted as drive signals for driving devices to be driven in order to produce modulated lights of individual three primaries, to change a white color temperature;
a matrix operation circuit for performing matrix operations on three color signals corresponding to the individual three primaries using the three color signals inputted and changeable matrix coefficients, thereby to output three new color signals; and
a control circuit for making a control to change said matrix coefficients and said correction values in conjunction with the change in each other.

4. An adjusting circuit according to claim 1,
wherein said correction values and said matrix coefficients satisfy such relationship that, in cases where the change of said correction values lead to drop of the color temperature, the change of matrix coefficients in associated with the change in said correction values shift the origin of green in the color space to red.

5. An adjusting circuit according to claim 2,
wherein said correction values and said matrix coefficients satisfy such relationship that, in cases where the change of said correction values lead to drop of the color temperature, the change of matrix coefficients in associated with the change in said correction values shift the origin of green in the color space to red.

6. An adjusting circuit according to claim 3,
wherein said correction values and said matrix coefficients satisfy such relationship that, in cases where the change of said correction values lead to drop of the color temperature, the change of matrix coefficients in associated with the change in said correction values shift the origin of green in the color space to red.

7. An image display apparatus comprising:
an adjusting circuit according to claim 1; and
a display panel for displaying an image in accordance with the three color signals outputted from said adjusting circuit.

8. An image display apparatus comprising:
an adjusting circuit according to claim 2; and
a display panel for displaying an image in accordance with the three color signals outputted from said adjusting circuit.

9. An image display apparatus comprising:
an adjusting circuit according to claim 3; and
a display panel for displaying an image in accordance with the three color signals outputted from said adjusting circuit.

10. A television set comprising:
an image display apparatus according to claim 7; and
a receiving circuit for receiving television signals to feed said image display apparatus with image data.

11. A television set comprising:
an image display apparatus according to claim 8; and
a receiving circuit for receiving television signals to feed said image display apparatus with image data.

12. A television set comprising:
an image display apparatus according to claim 9; and
a receiving circuit for receiving television signals to feed said image display apparatus with image data.

13. An adjusting method comprising:
a correction step of correcting fluorescent intensities of individual three primaries independently with changeable correction values to change a white color temperature; and
a matrix operation step of performing matrix operations on three color signals corresponding to the individual three primaries using the three color signals inputted and changeable matrix coefficients, thereby to output three new color signals,
wherein a control is made to change said matrix coefficients and said correction values in conjunction with the change in each other.

14. An adjusting method comprising:
a correction step of correcting three color signals corresponding to individual three primaries with changeable correction values to change a white color temperature; and
a matrix operation step of performing matrix operations on three color signals corresponding to the individual three primaries using the three color signals inputted and changeable matrix coefficients, thereby to output three new color signals,
wherein a control is made to change said matrix coefficients and said correction values in conjunction with the change in each other.

15. An adjusting method comprising:
a correction step of correcting such that drive signals corrected with changeable correction values are outputted as drive signals for driving devices to be driven in order to produce modulated lights of individual three primaries, to change a white color temperature; and
a matrix operation step of performing matrix operations on three color signals corresponding to the individual three primaries using the three color signals inputted and changeable matrix coefficients, thereby to output three new color signals,
wherein a control is made to change said matrix coefficients and said correction values in conjunction with the change in each other.

16. An adjusting method according to claim 13,
wherein said correction values and said matrix coefficients satisfy such relationship that, in cases where the change of said correction values lead to drop of the color temperature, the change of matrix coefficients in associated with the change in said correction values shift the origin of green in the color space to red.

17. An adjusting method according to claim 14,
wherein said correction values and said matrix coefficients satisfy such relationship that, in cases where the change of said correction values lead to drop of the color temperature, the change of matrix coefficients in associated with the change in said correction values shift the origin of green in the color space to red.

18. An adjusting method according to claim 15,
wherein said correction values and said matrix coefficients satisfy such relationship that, in cases where the change of said correction values lead to drop of the color temperature, the change of matrix coefficients in associated with the change in said correction values shift the origin of green in the color space to red.
